(19) United States
(12) Patent Application Publication
(10) Pub. No.: US 2007/0254798 A1
(43) Pub. Date: Nov. 1, 2007

(54) Peroxide containing compounds as pore formers in the manufacture of ceramic articles

(76) Inventors: William Peter Addiego, Big Flats, NY (US); Kevin Robert Brundage, Corning, NY (US); Christopher Raymond Glose, Painted Post, NY (US)

Correspondence Address: CORNING INCORPORATED, SP-TI-3-1, CORNING, NY, 14831, US

(21) Appl. No.: 11/394,696

(22) Filed: Mar. 31, 2006

(51) Int. Cl. C04B 35/03

(52) U.S. Cl. 501/119

(57) ABSTRACT

A method for manufacturing porous ceramic articles comprised of a primary sintered phase ceramic composition. The method includes the steps of providing a plasticized ceramic precursor batch composition including ceramic forming inorganic batch components; a liquid vehicle; an organic binder system; and a pore forming agent comprising at least one peroxide containing compound. An extruded green body is formed from the plasticized ceramic precursor batch composition and subsequently fired under conditions effective to convert the extruded green body into a ceramic article comprising a porous sintered phase composition. Also disclosed are ceramic article produced by the methods disclosed herein.

### BACKGROUND OF THE INVENTION

1. Field of the Invention

The present invention relates to ceramic articles and methods for manufacturing same. More particularly, the present invention relates to a method for manufacturing porous ceramic articles using a peroxide containing compound as a pore forming agent.

2. Technical Background

Recently, much interest has been directed towards the diesel engine due to its fuel efficiency, durability and economical aspects. However, diesel emissions have been scrutinized both in the United States and Europe. As such, stricter environmental regulations will likely require diesel engines to be held to similar standards as gasoline engines. Therefore, diesel engine manufacturers and emission-control companies are working to achieve a diesel engine which is faster, cleaner and meets stringent emissions requirements under all operating conditions with minimal cost to the consumer.

One of the biggest challenges in lowering diesel emissions is controlling the levels of diesel particulate material present in the diesel exhaust stream. Diesel particulate material consists mainly of carbon soot. One way of removing the carbon soot from the diesel exhaust is through the use of diesel traps (otherwise referred to as wall-flow filters” or “diesel particulate filters”). Diesel particulate filters capture the soot in the diesel exhaust on or in the porous walls of the filter body. The diesel particulate filter is designed to provide for nearly complete filtration of soot without significantly hindering the exhaust flow. However, as the layer of soot collects in the inlet channels of the diesel particulate filter, the lower permeability of the soot layer causes a gradual rise in the back pressure of the filter against the engine, causing the engine to work harder. Thus, once the carbon soot in the filter has accumulated to some level, the filter must be regenerated by burning out the soot, thereby restoring the back pressure again to low levels. Normally, this regeneration is accomplished under controlled conditions of engine management whereby a slow burn is initiated which lasts for a number of minutes, during which the temperature in the filter rises from a lower operational temperature to a maximum temperature.

Several refractory materials, being of relatively low-cost in combination with a relatively low coefficient of thermal expansion (CTE), such as cordierite, mullite and aluminum titanate, have been proposed for use in diesel exhaust filtration. To that end, porous ceramic filters of the wall-flow type have been utilized for the removal of particles in the exhaust stream from some diesel engines since the early 1980s. A diesel particulate filter (DPF) ideally should combine low CTE (for thermal shock resistance), low pressure drop (for fuel efficiency), high filtration efficiency (for high removal of particles from the exhaust stream), high strength (to survive handling, canning, and vibration in use), and low cost. However, achieving this combination of features has proven elusive in DPFs.

Thus, DPF design requires the balancing of several properties, including for example porosity, pore size distribution, thermal expansion, strength, elastic modulus, pressure drop, and manufacturability. Further, several engineering tradeoffs have been required in order to fabricate a filter having an acceptable combination of physical properties and processability.

For example, increased porosity is often attainable through the use of conventional pore forming agents that are typically organic particulates, such as graphite, added to the batch composition before shaping the article in the green state. In addition, starches or cellulose-bearing materials, such as cellulose ethers are sometimes used as pore formers. The pores are formed by the combustion of the pore former, resulting in pores bounded by the inorganic components. Depending upon the pore former and firing conditions, these pores may be retained to a large degree after firing to form the refractory article.

At issue with the use of these conventional pore formers is that the exothermic condition that arises during burn-out can lead to cracking of the ceramic and, thus, a reduction in the strength. To prevent or minimize this, the firing cycle used to convert a batch composition to the calcined state is ordinarily very slow. This is especially true in firing large cellular honeycombs for diesel particulate filters and catalyzed traps, and where large amounts of pore former (e.g., graphite) are needed to yield enough porosity, and specifically macroporosity, in the final state. Thus, it would be considered a significant advancement in the art to obtain a pore forming agent that can be used to provide refractory articles having an optimum pore microstructure without requiring a burn out period that can lead to cracking of the ceramic a reduction in the strength thereof.

### SUMMARY OF THE INVENTION

The present invention relates to porous ceramic refractory articles, and more particularly to a method for manufacturing porous ceramic articles wherein a peroxide containing compound is used as a pore forming agent.

In a first aspect, the present invention provides a plasticized ceramic precursor batch composition comprising ceramic forming inorganic batch components; a liquid vehicle; an organic binder system; and a pore forming agent comprising at least one peroxide containing compound. In a further aspect, the plasticized ceramic precursor batch composition is capable of forming a porous ceramic article comprising a primary sintered phase composition when fired under conditions effective to convert the precursor batch composition into a ceramic article.

In a second aspect, the present invention further provides method for producing a porous ceramic article comprising a primary sintered phase composition. The method comprises providing a plasticized ceramic precursor batch composition comprising ceramic forming inorganic batch components; a liquid vehicle; an organic binder system; and a pore forming agent comprising at least one peroxide containing compound. An extruded green body is formed from the plasticized ceramic precursor batch composition and subsequently fired under conditions effective to convert the extruded green body into a ceramic article comprising a porous sintered phase composition.

In still another aspect, the present invention provides an article produced by the methods of the present invention.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

The accompanying drawings, which are incorporated in and constitute a part of this specification, illustrate certain aspects of the instant invention and together with the description, serve to explain, without limitation, the principles of the invention.

FIG. 1 is a graph illustration comparing physical properties of inventive and comparative ceramic compositions according to one aspect of the present invention.

FIG. 2 is a graph illustration comparing physical properties of inventive and comparative ceramic compositions according to one aspect of the present invention.

FIG. 3 is a graph illustration comparing physical properties of inventive and comparative ceramic compositions according to one aspect of the present invention.

### DETAILED DESCRIPTION OF THE INVENTION

The present invention can be understood more readily by reference to the following detailed description, examples, and claims, and their previous and following description. However, before the present articles and/or methods are disclosed and described, it is to be understood that this invention is not limited to the specific articles and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used herein, the singular forms “a,” “an” and “the” include plural referents unless the context clearly dictates otherwise. Thus, for example, reference to a “pore former” includes aspects having two or more such pore formers, unless the context clearly indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, a “wt. %” or “weight percent” or “percent by weight” of an organic component, unless specifically stated to the contrary, is based on the total weight of the total inorganics in which the component is included. Organics are specified herein as superadditions based upon 100% of the inorganics used.

As briefly introduced above, the present invention provides an improved method for manufacturing porous ceramic articles that, for example, can be useful in ceramic filter applications. Among other aspects described in detail below, the inventive method comprises the use of a peroxide containing compound as a pore forming agent in the manufacture of porous ceramic articles. The peroxide containing compound can decompose to yield pore-generating gas (i.e., oxygen, carbon dioxide, nitrogen, etc.) at relatively low temperatures that are generally less than 400° C. Thus the use of peroxide containing pore forming agents can offer several processing advantages over the conventional pore forming agents that typically require a dedicated hold time at relatively high temperatures during the firing cycle in order to burn out the pore former by, for example, combustion. For example, in one aspect the use of a peroxide containing compound as a pore former can enable the use of a shorter firing schedule during processing, thus reducing the chances of the article cracking due to high exotherms.

Accordingly, the method of the present invention generally comprises the steps of first providing a plasticized ceramic precursor batch composition including inorganic ceramic forming batch component(s), a peroxide containing pore former, a liquid vehicle, and a binder; forming a green body having a desired shape from the plasticized ceramic precursor batch composition; and firing the formed green body under conditions effective to convert the green body into a porous ceramic article.

The inorganic batch components can be any combination of inorganic components which, upon firing, can provide a primary sintered phase composition. In one aspect, the inorganic batch components can be selected from a magnesium oxide source; an alumina-forming source; and a silica source. Still further, the batch components can be selected so as to yield a ceramic article comprising cordierite, mullite, spinel, aluminum titanate, or a mixture thereof upon firing. For example, and without limitation, in one aspect, the inorganic batch components can be selected to provide a cordierite composition consisting essentially of, as characterized in an oxide weight percent basis, from about 49 to about 53 percent by weight SiO₂, from about 33 to about 38 percent by weight Al₂O₃, and from about 12 to about 16 percent by weight MgO. To this end, an exemplary inorganic cordierite precursor powder batch composition preferably comprises about 33 to about 41 weight percent aluminum oxide source, about 46 to about 53 weight percent of a silica source, and about 11 to about 17 weight percent of a magnesium oxide source. Exemplary non-limiting inorganic batch component mixtures suitable for forming cordierite include those disclosed in U.S. Pat. Nos. 3,885,977; RE 38,888; 6,368,992; 6,319,870; 6,24,437; 6,210,626; 5,183,608; 5,258,150; 6,432,856; 6,773,657; 6,864,198; and U.S. Patent Application Publication Nos. 2004/0029707; 2004/0261384.

Alternatively, in another aspect, the inorganic batch components can be selected to provide mullite composition consisting essentially of, as characterized in an oxide weight percent basis, from 27 to 30 percent by weight SiO₂, and from about 68 to 72 percent by weight Al₂O₃. An exemplary inorganic mullite precursor powder batch composition can comprise approximately 76% mullite refractory aggregate; approximately 9.0% fine clay; and approximately 15% alpha alumina. Additional exemplary non-limiting inorganic batch component mixtures suitable for forming mullite include those disclosed in U.S. Pat. Nos. 6,254,822 and 6,238,618.

Still further, the inorganic batch components can be selected to provide alumina titanate composition consisting essentially of, as characterized in an oxide weight percent basis, from about 8 to about 15 percent by weight SiO₂, from about 45 to about 53 percent by weight Al₂O₃, and from about 27 to about 33 percent by weight TiO₂. An exemplary inorganic aluminum titanate precursor powder batch composition can comprises approximately 10% quartz; approximately 47% alumina; approximately 30% titania; and approximately 13% additional inorganic additives. Additional exemplary non-limiting inorganic batch component mixtures suitable for forming aluminum titanate include those disclosed in U.S. Pat. Nos. 4,483,944; 4,855,265; 5,290,739; 6,620,751; 6,942,713; 6,849,181; U.S. Patent Application Publication Nos.: 2004/0020846; 2004/0092381; and in PCT Application Publication Nos. WO 2006/015240; WO 2005/046840; and WO 2004/011386.

The inorganic ceramic batch components can be synthetically produced materials such as oxides, hydroxides, and the like. Alternatively, they can be naturally occurring minerals such as clays, talcs, or any combination thereof. Thus, it should be understood that the present invention is not limited to any particular types of powders or raw materials, as such can be selected depending on the properties desired in the final ceramic body.

In one aspect, an exemplary and non-limiting magnesium oxide source can comprise talc. In a further aspect, suitable talcs can comprise talc having a mean particle size of at least about 5 μm, at least about 8 μm, at least about 12 μm, or even at least about 15 μm. Particle size is measured by a particle size distribution (PSD) technique, preferably by a Sedigraph by Micrometrics. Talc have particle sizes of between 15 and 25 μm are preferred. In still a further aspect, the talc can be a platy talc. As used herein, a platy talc refers to talc that exhibits a platelet particle morphology, i.e., particles having two long dimensions and one short dimension, or, for example, a length and width of the platelet that is much larger than its thickness. In one aspect, the talc possesses a morphology index (MI) of greater than about 0.50, 0.60, 0.70, or 80. To this end, the morphology index, as disclosed in U.S. Pat. No. 5,141,686, is a measure of the degree of platiness of the talc. One typical procedure for measuring the morphology index is to place the sample in a holder so that the orientation of the platy talc is maximized within the plane of the sample holder. The x-ray diffraction (XRD) pattern can then be determined for the oriented talc. The morphology index semi-quantitatively relates the platy character of the talc to its XRD peak intensities using the following equation:

$$M = \frac{{I}_{x}}{{I}_{x} + 2 {I}_{y}}$$

where Iₓ is the intensity of the peak and I_{y} is that of the reflection.

Exemplary alumina forming sources can include aluminum oxides or a compound containing aluminum which when heated to sufficiently high temperature yields essentially 100% aluminum oxide. Non-limiting examples of alumina forming sources include corundum or alpha-alumina, gamma-alumina, transitional aluminas, aluminum hydroxide such as gibbsite and bayerite, boehmite, diaspore, aluminum isopropoxide and the like. Commercially available alumina sources can include relatively coarse aluminas, having a particle size of between about 4-6 micrometers, and a surface area of about 0.5-1 m²/g, and relatively fine aluminas having a particle size of between about 0.5-2 micrometers, and a surface area of about 8-11 m²/g.

If desired, the alumina source can also comprise a dispersible alumina forming source. As used herein, a dispersible alumina forming source is an alumina forming source that is at least substantially dispersible in a solvent or liquid medium and that can be used to provide a colloidal suspension in a solvent or liquid medium. In one aspect, a dispersible alumina source can be a relatively high surface area alumina source having a specific surface area of at least 20 m²/g. Alternatively, a dispersible alumina source can have a specific surface area of at least 50 m²/g. In an exemplary aspect, a suitable dispersible alumina source for use in the methods of the instant invention comprises alpha aluminum oxide hydroxide (AIOOH.x.H₂O) commonly referred to as boehmite, pseudoboehmite, and as aluminum monohydrate. In another exemplary aspect, the dispersible alumina source can comprise the so-called transition or activated aluminas (i.e., aluminum oxyhydroxide and chi, eta, rho, iota, kappa, gamma, delta, and theta alumina) which can contain various amounts of chemically bound water or hydroxyl functionalities.

Suitable silica forming sources can in one aspect comprise clay or mixtures, such as for example, raw kaolin, calcined kaolin, and/or mixtures thereof. Exemplary and non-limiting clays include non-delaminated kaolinite raw clay, having a particle size of about 7-9 micrometers, and a surface area of about 5-7 m²/g, clays having a particle size of about 2-5 micrometers, and a surface area of about 10-14 m²/g, delaminated kaolinite having a particle size of about 1-3 micrometers, and a surface area of about 13-17 m²/g, calcined clay, having a particle size of about 1-3 micrometers, and a surface area of about 6-8 m²/g.

In a further aspect, it should also be understood that the silica forming source can further comprise, if desired, a silica raw material including fused SiO₂; colloidal silica; crystalline silica, such as quartz or cristobalite, or a low-alumina substantially alkali-free zeolite. Further, in still another aspect, the silica forming source can comprise a compound that forms free silica when heated, such as for example, silicic acid or a silicon organo-metallic compound.

As set forth above, the plasticized ceramic precursor batch composition further comprises a peroxide containing compound as a pore forming agent. As used herein, a pore former is a fugitive material which can decompose, evaporate and/or undergo vaporization by combustion during drying or heating of the green body to obtain a desired, usually larger porosity and/or coarser median pore diameter than would otherwise be obtained. Conventional pore formers can typically be any particulate substance that “burns out” of the formed green body during the firing step and can include such exemplary and non-limiting burnout agents as elemental carbon, graphite, cellulose, flour, and the like. In use, the pore forming peroxide compound of the present invention decomposes to yield pore-generating gas (i.e., oxygen, carbon dioxide, nitrogen, etc.) at relatively low temperatures that are generally less than 400° C. As illustrated in the examples below, the resulting pore microstructure that is formed by the evolving decomposition gases is further retained in the ceramic article after firing at temperatures greater than 1200° C. Further, because the pore forming peroxide compounds decompose at low temperatures, a desired pore microstructure can be formed while drying a formed green body rather than during a burn out cycle at temperatures greater than 1200° C. Thus, it will be appreciated that the peroxide containing pore former can enable the use of a shorter firing schedule during processing which can, for example, provide an increased article strength by reducing article cracking that can result from high exotherms during conventional firing schedules.

Peroxide containing compounds that are suitable for use as a pore forming agent according to the method of the present invention include both organic and inorganic peroxides. More specifically, suitable peroxide containing compounds can include simple peroxides, hydroperoxides, peroxyhydrates, alkali carbonate peroxyhydrates such as sodium carbonate peroxyhydrate, alkaline earth peroxides, and transition metal peroxides, perborates and persulfates. In another aspect, the suitable peroxide containing compound can include adducts of salts, such ammonium or sodium carbonate and bicarbonate, to form so-called percarbonate compounds. Still further, the peroxide containing compound can also be present in any amount effective to provide a desired porosity. However, in one aspect, the peroxide containing compound is present in an amount in the range of from about 0.5 weight percent to about 5 weight percent, including exemplary weight percentages of 1.0, 1.5, 2.0, 2.5, 3.0, 3.5, 4.0 and 4.5 weight percent.

In one aspect, the peroxide pore forming agent can be hydrogen peroxide. The hydrogen peroxide can, for example, be introduced into the ceramic batch composition as a dilute solution, i.e, an approximately 10%-50% solution of hydrogen peroxide, including 15%, 20%, 25%, 30%, 35%, 40%, and 45% hydrogen peroxide solutions. In one aspect, the dilute hydrogen peroxide is approximately a 20-40%, more preferably about 30% solution of hydrogen peroxide. The hydrogen peroxide can decompose relatively slowly at ambient temperatures but such decomposition will accelerate with increased heat, thus resulting in oxygen gas evolving as the hydrogen peroxide (hp) decomposes in an extruded or otherwise formed plasticized ceramic precursor composition. As the oxygen evolves, it forms pores in the body and channels of the precursor batch composition and eventually finds its way to the surface where it can escape into the atmosphere. This process typically occurs after extrusion and with the increased heating provided during the drying stage, typically at a temperature below 400° C. As the formed green body stiffens with drying, the rate of porosity formation from the hydrogen peroxide decreases.

In addition, other optional pore forming additives can be present in the batch composition in order to further affect the evolution of pores. For example, an acid and/or base can be introduced in order to control the effect of pH on the hydrogen peroxide reaction. More specifically, in one aspect, the pH of the batch composition can be controlled so as to yield active intermediates, such as hydrogen disproportionation to yield HOO⁻ ions. To this end, a reduction/oxidation coupling reaction can further evolve gases in addition to oxygen, including for example, nitrogen and nitrogen oxides. In still another aspect, the present invention further contemplates the use of a peroxide pore forming agent, such as hydrogen peroxide, in combination with interactive organics, e.g., acrylic ester latexes, poly vinyl alcohol, and the like, to yield in situ foams within the ceramic batch composition.

Similarly, although not required, an optional burn out agent can also be used as a pore former in combination with the peroxide containing compound. An optional burn out agent can, for example, include any fugitive particulate material which evaporates or undergoes vaporization by combustion during drying or heating of the green body to further obtain a desired, usually larger porosity and/or coarser median pore diameter than would otherwise be obtained. Exemplary and non-limiting optional burnout agents that can be used include organics that are solid at room temperature, elemental carbon, and combinations of these. Further examples can include graphite, cellulose, sugars, flour, starches, and the like.

The inorganic batch components and the pore former agent can be intimately blended with a liquid vehicle and optional forming aids which impart plastic formability and green strength to the raw materials when they are shaped into a body. Forming may be done by, for example, molding or extrusion. When forming is done by extrusion, most typically a cellulose ether binder such as methylcellulose, hydroxypropyl methylcellulose, methylcellulose derivatives, and/or any combinations thereof, serve as a binder, and sodium stearate or oleic acid serves as a lubricant. The relative amounts of forming aids can vary depending on factors such as the nature and amounts of raw materials used, etc. For example, the typical amounts of forming aids are about 2% to about 10% by weight of methyl cellulose, and preferably about 3% to about 6% by weight, and about 0.5% to about 2% by weight sodium stearate or oleic acid, and preferably about 1.0% by weight. The raw materials and the forming aids are typically mixed together in dry form and then mixed with water as the vehicle. The amount of water can vary from one batch of materials to another and therefore is determined by pre-testing the particular batch for extrudability.

The liquid vehicle component can vary depending on the type of material used in order to in part optimum handling properties and compatibility with the other components in the ceramic batch mixture. Typically, the liquid vehicle content is usually in the range of from 20% to 50% by weight of the plasticized composition. In one aspect, the liquid vehicle component can comprise water.

As described above, the peroxide containing compound, i.e., hydrogen peroxide, decomposes relatively slowly at ambient temperatures and such decomposition typically does not accelerate until subjected to increased heating. Thus, the resulting stiff, uniform, and extrudable plasticized ceramic precursor batch composition comprising the peroxide pore forming agent can be shaped into a green body by any known conventional ceramic forming process, such as, e.g., extrusion, injection molding, slip casting, centrifugal casting, pressure casting, dry pressing, and the like prior to any substantial decomposition of the pore former and subsequent pore forming gas evolution. In an exemplary aspect, extrusion can be done using a hydraulic ram extrusion press, or a two stage de-airing single auger extruder, or a twin screw mixer with a die assembly attached to the discharge end. In the latter, the proper screw elements are chosen according to material and other process conditions in order to build up sufficient pressure to force the batch material through the die.

The instant method and the resulting ceramic articles are in one aspect especially suited for use as diesel particulate filters. Specifically, the inventive ceramic articles are especially suited as multi-cellular honeycomb articles having a relatively high modulus of rupture in combination with a relatively high flux capacity of flow through permeability. To this end, in one aspect the plasticized ceramic precursor batch composition can be formed or otherwise shaped into a honeycomb configuration. Although a honeycomb ceramic filter of the present invention normally has a structure in which a plurality of through holes opened to the end surface of the exhaust gas flow-in side and to the end surface of the exhaust gas flow-out side are alternately sealed at both the end surfaces, the shape of the honeycomb filter is not particularly restricted. For example, the filter may be a cylinder having end surfaces with a shape of a circle or an ellipse, a prism having the end surfaces with a shape of a polygon such as a triangle or a square, a shape in which the sides of these cylinder and prism are bent like an “doglegged shape,” or the like. In addition, the shape of through holes is not particularly limited. For example, the sectional shape may be a polygon, such as a square, a hexagon, an octagon, a circle, an ellipse, a triangle, or other shapes or combinations. It should however be understood that the particular desired size and shape of the ceramic article can depend on the application, e.g., in automotive applications by engine size and space available for mounting, etc.

The formed green body having a desired size and shape as described above can then be dried to remove excess moisture therefrom. Additionally, as described above, the drying step can also initiate the decomposition of the peroxide composition resulting in the evolution of pore forming gases. The drying step can be carried out by any known method, including for example, microwave, hot air, autoclave, convection, humidity controlled, freeze drying, critical drying, and any other method that can affect the extent and rate of peroxide decomposition within the formed green body. In one exemplary aspect, the green body can be dried at a temperature less than 400° C., less than 350° C., less than 300° C., less than 250° C., less than 200° C., or even less than 150° C.

In still another aspect, the microstructure of the resulting ceramic article can be controlled and/or optimized to provide a desired microstructure by selecting optimized drying conditions. For example, exemplary drying conditions can include rapid heating with microwave or dielectrically generated heat in the material that can provide homogeneous pore formation as a result of hydrogen peroxide decomposition. The amount of power used can range from several hundred to tens of kilowatts and the duration of drying can be dependent on the size of the ceramic article and composition. In one aspect, the temperature can be raised above 50° C. rapidly to decompose the hydrogen peroxide and intermediates, evolving gases and creating pores as the gas, generally oxygen, escapes the ceramic article.

Once dried, the green body can thereafter be fired under conditions effective to convert the green body into a ceramic article comprising a primary crystalline phase ceramic composition as described below.

The firing conditions effective to convert the green body into a ceramic article can vary depending on the process conditions such as, for example, the specific composition, size and/or shape of the green body, and nature of the equipment used. To that end, in one aspect, the optimal firing conditions specified herein may need to be adapted for very large cordierite structures, i.e., slowed down, for example. However, in one aspect, for plasticized mixtures that are primarily for forming cordierite, the firing conditions comprise heating the green body to a maximum soak temperature of between about 1350° C. to about 1450° C. In still another aspect, the green body can be fired at a soak temperature in the range of from about 1400° C. to about 1450° C. In still yet another aspect, the green body may be fired at a soak temperature in the range of from about 1415° C. to about 1435° C., including a preferred soak temperature of, for example, of between about 1420° C. and about 1430° C.

The firing times can also range from approximately 40 to 250 hours, during which a maximum soak temperature can be reached and held for a soak time in the range of from about 5 hours to about 50 hours, more preferably between about 10 hours to about 40 hours. In still another aspect, the soak time may be in the range of from about 15 hours to about 30 hours. A preferred firing schedule includes firing at a soak temperature of between about 1415° C. and 1435° C. for between about 10 hours to about 35 hours.

As briefly stated above, and as further exemplified in the appended examples, the use of the peroxide containing compounds, such as hydrogen peroxide, as a pore former in the plasticized ceramic precursor batch composition of the present invention can further enable the use of processing conditions that provide a resulting ceramic article having a unique combination of microstructure characteristics and performance properties. For example, in one aspect, the use of hydrogen peroxide enables a reduction in the required overall firing cycle time by minimizing or eliminating the firing cycle hold periods typically used for conventional pore-former burnout. For example, an exemplary firing cycle can comprise increasing the firing temperature from ambient or 25° C. at a rate of approximately 2°/min to a soak temperature in the range of from 1425 to 1440° C. and holding the soak temperature for approximately 15 hours, followed by cooling to 25-28° C. at a rate of approximately 2°/min.

It should be appreciated that the hydroxide containing pore forming agents can be used to manufacture ceramic articles having any desired microstructure and further exhibiting any desired performance property or combination of performance properties. For example, a ceramic article can be produced possessing a microstructure characterized by a unique combination of relatively high porosity (but not too high) that can provide improved flow through properties within the material and still exhibit a high strength and chemical durability. The resulting ceramic structure can therefore be useful for ceramic filter applications requiring high thermal durability and high filtration efficiency coupled with low pressure drop across the filter. Such ceramic articles are particularly well suited for filtration applications, such as diesel exhaust filters.

In another aspect, the method of the present invention can further provide ceramic articles having any desired porosity. For example, the total porosity (% P) of the inventive ceramic bodies, as measured by mercury porosimetry, can in one aspect be greater than 40%. In another aspect, the total porosity of the ceramic article can be from greater than 40% to less than 65%. In still another aspect of the invention, the porosity can be less than 60%; less than 55%; or even less than 50%. In still another aspect of the invention, the porosity can be in the range of greater than 42% to less than 55%; or even 46% to less than 52%. Achieving relatively lower porosity while still achieving sufficiently low back pressure across the article is desired in that it provides higher strength.

In still a further aspect, the inventive method can be used to provide porous ceramic articles having any desired pore size distribution. To that end, the porosity microstructure parameters d₁₀, d₅₀ and d₉₀ relate to the pore size distribution and are used herein, among other parameters, to characterize a pore size distribution. The quantity d₅₀ is the median pore diameter based upon pore volume, and is measured in μm; thus, d₅₀ is the pore diameter at which 50% of the open porosity of the ceramic honeycomb article has been intruded by mercury. The quantity d₉₀ is the pore diameter at which 90% of the pore volume is comprised of pores whose diameters are smaller than the value of d₉₀; thus, d₉₀ is equal to the pore diameter at which 10% by volume of the open porosity of the ceramic has been intruded by mercury. The quantity d₁₀ is the pore diameter at which 10% of the pore volume is comprised of pores whose diameters are smaller than the value of d₁₀; thus, d₁₀ is equal to the pore diameter at which 90% by volume of the open porosity of the ceramic has been intruded by mercury. The values of d₁₀ and d₉₀ are also in units of microns.

In one aspect, the median pore diameter, d₅₀, of the pores present in the instant ceramic articles can, in one aspect, be at least 15 μm. In another aspect, the median pore diameter, d₅₀, is at least 25 μm. In another aspect, the median pore diameter, d₅₀, can be in the range of from 15 μm to 25 μm; or even 15 μm to 20 μm. These ranges provide suitable filtration efficiencies. In an alternative aspect, the median pore diameter, d₅₀, of the pores present in the instant ceramic articles is less than 15 μm. In another aspect, the median pore diameter d₅₀ is less than 10 μm, or even less than 5 μm. In still another aspect, the median pore diameter d₅₀ is in the range of from 3 μm to 10 μm, or even from 3 μm to 5 μm.

In another aspect, the ceramic articles of the present invention can exhibit a relatively high strength, as indicated by their modulus of rupture (MOR). For purposes of the present invention, modulus of rupture can be tested and evaluated based upon an inventive ceramic article of the present invention having 200 cells per inch-squared and webs 0.016-inch thick. However, it should be understood that any cell density and web thickness can be used. Thus, in one aspect, the ceramic articles of the present invention can have a modulus of rupture of at least 300 psi. In a further aspect, the modulus of rupture can be at least 1000 psi, at least 2000 psi, at least 3000 psi, at least 4000 psi, or even at least 5000 psi.

In still a further aspect, the use of a peroxide containing pore forming agent in the manufacture of refractory ceramic articles can result in a relatively high permeability in combination with the relatively high strengths described above. As will be appreciated, a relatively high flow through or permeability coupled with high strength and chemical durability can provide several commercial advantages, such as reduced pressure drop across the ceramic body, increased filtration efficiency, added flexibility in article geometry, an increased product durability. In one aspect, the present invention provides a ceramic article comprising a permeability, as measured by mercury porosimetry, of at least 150 mDarcy. In still another aspect, the permeability can be at least 300 mDarcy, at least 400 mDarcy, or even at least 500 mDarcy. In still another aspect, the permeability can be in the range of from 150 mDarcy to 500 mDarcy.

### EXAMPLES

To further illustrate the principles of the present invention, the following examples are put forth so as to provide those of ordinary skill in the art with a complete disclosure and description of how the ceramic articles and methods claimed herein are made and evaluated. They are intended to be purely exemplary of the invention and are not intended to limit the scope of what the inventors regard as their invention. Efforts have been made to ensure accuracy with respect to numbers (e.g., amounts, temperatures, etc.); however, some errors and deviations may have occurred. Unless indicated otherwise, parts are parts by weight, temperature is ° C. or is at ambient temperature, and pressure is at or near atmospheric.

The exemplified ceramic articles were evaluated for relevant physical and performance properties, such as for example, total porosity, median pore diameter, pore size distribution, permeability, intrusion volume, and modulus of rupture. All measurements of pore microstructure were made by mercury porosimetry using a Autopore IV 9520 by Micrometrics. Modulus of rupture (MOR) was measured on honeycomb bodies and in the axial direction by the four-point method. The material permeability was measured using the Hg porosity equipment.

### Example 1

### Mullite

In a first example, a series of ceramic mullite articles were prepared using various combinations of starting raw materials including alumina-forming sources, silica-forming sources, binder, pore former, liquid vehicle, and lubricant and/or surfactant. The specific powder batch compositions used to prepare the exemplary mullite honeycomb articles are set forth in Table 1 below.

TABLE 1
Mullite Batch Compositions (Wt. %)

| Sample ID | % | | | | |
|---|---|---|---|---|---|
| Batch | Hydrogen | Weight % | | | |
| Composition | Peroxide | Mullite | Clay | Alumina | Graphite |
| EJQ - 166 (A) | 0 | 90 fine | 10 | 0 | 0 |
| EIK - 166 (B) | 0 | 77 fine | 8 | 15 | 0 |
| EIR - 166 (C) | 0 | 63 coarse | 7 | 0 | 30 |
| ICT - 166 (D) | 1 | 77 fine | 8 | 15 | 0 |
| ICU - 166 (E) | 1 | 77 coarse | 8 | 15 | 0 |

To manufacture the mullite articles, the dry batch compositions listed in Table 1 were charged to a Littleford mixer and then followed by the liquid vehicle addition. The pore former, binder and lubricant and/or surfactant are added as superadditions based upon wt. % of 100% of the inorganic materials. Specifically, these powder batch compositions were extruded with 6 wt % Methocel binder, 1 wt % sodium stearate lubricant, and water as the liquid vehicle. The liquid vehicle addition included between 20 and 32 wt. % as a superaddition based upon wt. % of 100% of the inorganic materials. After the liquid addition, the composition was mixed for approximately 3 minutes. The resulting mixture was then mulled in a large muller for approximately 5-20 minutes to provide a final plasticized ceramic batch mixture.

Each of the plasticized batches was then formed into a wet or green round cell monolith having 50 cells per square inch (cpsi). The wet or green wares are then dried immediately using a microwave or RF drier to preferably reach greater than approximately 90% drying and to accelerate the evolution of pore forming gas from the peroxide decomposition in the inventive compositions. A conventional furnace is then used to remove any additional organics, to further dehydrate the raw materials, and to fire the green bodies and form the ceramic articles containing mullite. Typical firing conditions for mullite are set forth below in Table 2:

TABLE 2
Typical Mullite Firing Conditions
Mullite Firing Schedule

| Temperature | Ramp Rate, | |
|---|---|---|
| Range, ° C. | ° C./Hr | Dwell, Hr |
| 25-350 | 20 | |
| 350-1495 | 50 | |
| 1495 | 0 | 10 |
| 1495-25 | 75 | |

The resulting articles were then evaluated to determine their relevant physical properties, such as for example, total porosity, median pore diameter, pore size distribution, permeability, intrusion volume, and modulus of rupture. The test results are reported in Table 3 below.

TABLE 3
Physical Properties of Fired Mullite Compositions

| Sample ID | Properties | | | | | | | |
|---|---|---|---|---|---|---|---|---|
| Batch | | Intrusion | d₅₀ | d₁₀ | d₉₀ | | Hg Permeability | MOR |
| Composition | % P | (cc/g) | (μm) | (μm) | (μm) | d_{factor} | (mDarcy) | (psi) |
| EJQ - 166 (A) | 39.5 | 0.2020 | 5.0 | 3.4 | 5.7 | 0.31 | 18 | 5304 |
| EIK - 166 (B) | 40.4 | 0.2047 | 3.3 | 2.3 | 4.1 | 0.31 | 7 | 4597 |
| EIR - 166 (C) | 62.6 | 0.5024 | 12.3 | 5.7 | 17.4 | 0.54 | 238 | 202 |
| ICT - 166 (D) | 42.0 | 0.2329 | 3.5 | 1.7 | 37.2 | 0.50 | 357 | 4564 |
| ICU - 166 (E) | 42.8 | 0.2354 | 5.0 | 2.0 | 42.4 | 0.60 | 156 | 3099 |

An examination of the data set forth in Table 2 indicates the ability for an inventive batch composition of the present invention to provide a resulting fired ceramic mullite body having the unique combination of microstructure and performance properties described herein. For example, Table 3 illustrates the ability to achieve a ceramic article having an increased flux capacity or flow potential through the ceramic article without sacrificing the materials strength and chemical durability.

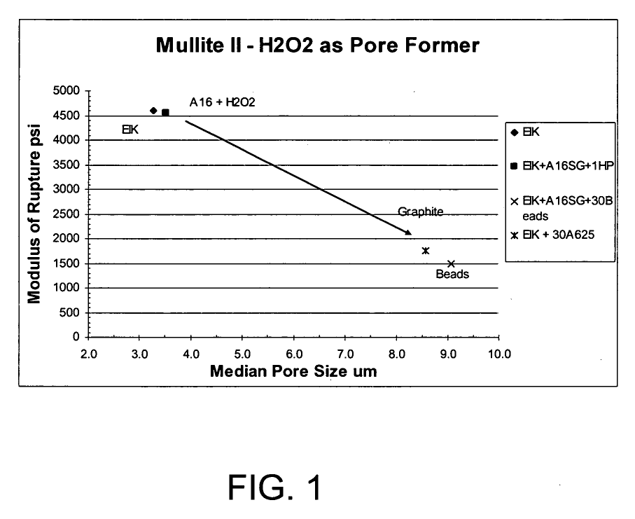

Specifically, the two compositions containing Hydrogen Peroxide (H₂O₂) as a pore former (Batches D & E) show excellent permeability combined with relatively low median pore sizes. Compared with Batch B, Batches D and E show high strength and high permeability without other pore formers, such as graphite, which lowers strength. This is a desirable combination with low median pore size as an indicator of high strength and chemical durability. By way of comparison, FIG. 1 further illustrates that the compositions containing the H₂O₂ pore former retain a high MOR while the compositions containing the conventional burn out pore formers do not.

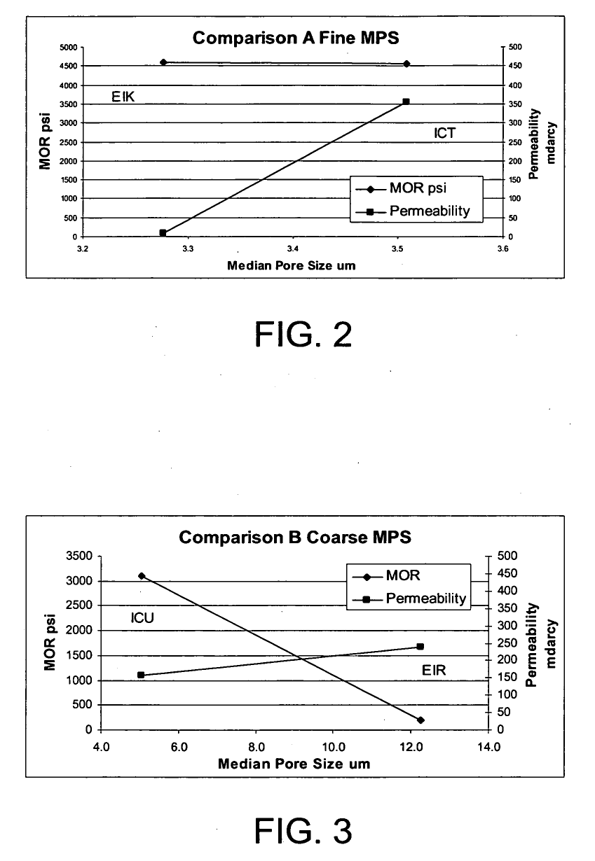

With reference to FIGS. 2 and 3, two additional comparisons are made using two different starting particle sizes of the base Mullite materials. Specifically, FIGS. 2 and 3 show the median pore size, MOR and Hg permeability for each particle size Mullite, with and without the H₂O₂ pore former. In each case when the H₂O₂ pore former was added, a fine alumina was also added. As shown in FIG. 2, the fine Mullite material, EIK composition shows very little (0.2 μm) increase in MPS, approximately the same MOR and large increase in Hg permeability from 7 mdarcy to 357 mdarcy with the addition of the alumina and H₂O₂ pore former. Thus, FIG. 2 illustrates that the use of hydrogen peroxide pore former in a batch composition comprising relatively fine mullite raw materials provides a significant increase in permeability while also maintaining a high strength that corresponds to a relatively small median pore size.

FIG. 3 illustrates a comparison of a more coarse Mullite composition with a graphite pore former EIR, and the ICU composition which has H₂O₂ replacing graphite, and the addition of the fine alumina. In this comparison, the median pore size dropped from 12.3 μm to 5 μm, the MOR increases from 202 psi to 3099 psi and the Hg permeability is decreased somewhat from 238 mdarcy to 156 mdarcy. Thus, the H₂O₂ pore former appears to have a particular affect on the coarse pores in the distribution. In both cases, the d₉₀ (pore size at which 10% of the porosity is greater) increased substantially while the median pore size remained almost the same or even decreased. Specifically, the comparisons show the d₉₀ increasing from 4.1 μm to 37.2 μm and 17.4 μm to 42.4 μm. This appears to broaden the coarse end of the distribution while keeping the MPS low.

Accordingly, FIG. 3 further indicates the strength and pore size benefits of using the H₂O₂ pore former in place of graphite. More specifically, coarse particle size materials can be used to yield high permeabilities however strength is generally very poor. The EIR composition has a very coarse MPS and good permeability but very low strength. However, the ICU composition with A16sg and 1% HP exhibits a drop in MPS and a significant increase in strength while still maintaining a relatively high Hg permeability.

### Example 2

### Cordierite

In a second set of examples, a series of exemplary ceramic cordierite articles were prepared using various combinations of starting raw materials including talc, kaolin, alumina-forming sources, silica-forming sources, binder, pore former, liquid vehicle, and lubricant and/or surfactant. The specific powder batch compositions used to prepare the cordierite honeycomb articles are set forth in Table 4 below.

TABLE 4
Cordierite Batch Compositions (Wt. %)

| Sample ID | Composition | | | | | |
|---|---|---|---|---|---|---|
| Batch | | % Magnesium | | | | % Hydrogen |
| Composition | % Alumina | Hydroxide | % Talc | % Quartz | % Graphite | Peroxide |
| VLD1141 (F) | 33.4 | | 43.2 | 23.4 | 10 | |
| VLO1160 (G) | 33.4 | | 43.2 | 23.4 | | 0.2 |
| VLR1168 (H) | 33.4 | 18.6 | | 23.4 | | 0.5 |

To manufacture the inventive and comparative cordierite articles, the dry batch compositions listed in Table 4 were charged to a Littleford mixer and then followed by the liquid vehicle addition. The pore former, binder and lubricant and/or surfactant are added as superadditions based upon wt. % of 100% of the inorganic materials. Specifically, these compositions were extruded with 6 wt % Methocel, 1 wt % sodium stearate, and water as the liquid vehicle. The liquid vehicle addition included between 20 and 32 wt. % of the liquid vehicle as a superaddition based upon wt. % of 100% of the inorganic materials. After the liquid addition, the composition is mixed for approximately 3 minutes. The resulting mixture is then mulled in a large muller for approximately 5-20 minutes to provide a final plasticized ceramic batch mixture.

Each of the plasticized batches was then formed into a wet or green honeycomb article having 200 cells per inch-squared (200 cpsi) with cell walls 0.016″ (16 mil) thick. The wet or green honeycomb wares are then dried immediately using a microwave or RF drier to preferably reach greater than approximately 90% drying and to accelerate the evolution of pore forming gas from the peroxide decomposition in the inventive compositions. A conventional furnace is then used to remove any additional organics, to further dehydrate the raw materials, and to fire the green bodies and form the ceramic articles containing cordierite. Green honeycombs were fired in air from 25° C. at a ramp rate of 2°/min to 1425° C. and held at that temperature for 15 hours and then cooled to ambient temperature (25-28° C.) at a rate of 2°/min.

The resulting articles were then evaluated to determine their relevant physical properties, such as for example, total porosity, median pore diameter, pore size distribution, permeability, intrusion volume, and modulus of rupture. The test results are reported in Table 5 below.

TABLE 5
Physical Properties of Fired Cordierite Compositions

| Sample ID | Properties | | | | | |
|---|---|---|---|---|---|---|
| Batch | | Intrusion | d₅₀ | MOR - 400° C. | MOR - 800° C. | MOR - 1425° C. |
| Composition | % P | (cc/g) | (μm) | (psi) | (psi) | (psi) |
| VLD - 1141 (F) | 50.49 | 0.43 | 18.4 | 0 | 0 | 2496 |
| VLO - 1160 (G) | 49.2 | 0.37 | 23.6 | 416 | 298 | 1759 |
| VLR - 1168 (H) | 47.59 | 0.35 | 24.85 | 333 | 243 | 2691 |

An examination of the data set forth in Table 5 indicates the results of cordierite compositions that were treated with hydrogen peroxide without graphite or other pore former and compared with a reference, VLD-1141 containing 10% Asbury A625 graphite. As shown in Table 5, after firing at 1425° C. to form cordierite, the total porosity % P was very high, 47-49% with median pore size of 20-25 μm, actually larger than provided by graphite in the reference case. In addition, the final strength of the composition was not compromised by the presence of the hydrogen peroxide treatment.

### Example 3

### Aluminum Titanate

In still a third example, a series of aluminum titanate articles were prepared using various combinations of starting raw materials including alumina-forming sources, silica-forming sources, binder, pore former, liquid vehicle, and lubricant and/or surfactant. The specific powder batch compositions used to prepare the aluminum titanate (AT) honeycomb articles are set forth in Table 6 below. The inorganic additives included hydrated alumina and certain alkaline and rare earth salts and oxides. Additionally, for samples HKQ(J-L), amorphous alumina was also added.

TABLE 6
AT Batch Compositions (Wt. %)

| Sample ID | Composition | | | | | | |
|---|---|---|---|---|---|---|---|
| Batch | | % Amorphous | % Refractory | | % Inorganic | | % Hydrogen |
| Extrusion | % Silica | Alumina | Alumina | % Titania | Additives | % Graphite | Peroxide |
| HKQ (I) | 10 | 0 | 47 | 30 | 13 | 30 | 0 |
| HKQ (J) | 10 | 8 | 39 | 30 | 13 | 0 | 0.5 |
| HKQ (K) | 10 | 8 | 39 | 30 | 13 | 10 | 0.5 |
| HKQ (L) | 10 | 8 | 39 | 30 | 13 | 10 | 0.5 |

To manufacture the inventive and comparative aluminum titanate articles, the dry batch compositions listed in Table 6 were charged to a Littleford mixer and then followed by the liquid vehicle addition. The pore former, binder and lubricant and/or surfactant are added as superadditions based upon wt. % of 100% of the inorganic materials. Specifically, the compositions were extruded with 4.5 wt % Methocel binder, 16 wt % oleic acid aqueous emulsion, and water as the liquid vehicle. The liquid vehicle addition included between 20 and 32 wt. % of the liquid vehicle as a superaddition based upon wt. % of 100% of the inorganic materials. After the liquid addition, the composition is mixed for approximately 3 minutes. The resulting mixture is then mulled in a large muller for approximately 5-20 minutes to provide a final plasticized ceramic batch mixture.

Each of the plasticized batches was then formed into a wet or green honeycomb article having 200 cells per inch-squared (200 cpsi) with cell walls 0.016″ (16 mil) thick. The wet or green honeycomb wares are then dried immediately using a microwave or RF drier to preferably reach greater than approximately 90% drying and to accelerate the evolution of pore forming gas from the peroxide decomposition in the inventive compositions. A conventional furnace is then used to remove any additional organics, to further dehydrate the raw materials, and to fire the green bodies and form the ceramic articles containing mullite. Green honeycombs were fired in air from 25° C. at a ramp rate of 2°/min to 1440° C. and held at that temperature for 6 hours and then cooled to ambient temperature (25-28° C.) at a rate of 2°/min.

The resulting articles were then evaluated to determine their relevant physical properties, such as for example, total porosity, median pore diameter, pore size distribution, permeability, intrusion volume, and modulus of rupture. The test results are reported in Table 7 below.

TABLE 7
Physical Properties of Fired Aluminum Titanate

| Sample ID | Properties | | | | | |
|---|---|---|---|---|---|---|
| Batch | | Intrusion | d₅₀ | MOR - 400° C. | MOR - 800° C. | MOR - 1425° C. |
| Extrusion | % P | (cc/g) | (μm) | (psi) | (psi) | (psi) |
| HKQ (I) | 53 | 0.32 | 18 | 0 | 79 | 714 |
| HKQ (J) | 44 | 0.23 | 15 | 129 | 253 | 800 |
| HKQ (K) | 62 | 0.46 | 38 | — | — | — |
| HKQ (L) | 59 | 0.43 | 33 | — | — | — |

An examination of the data set forth in Table 7 indicates the effective use of Hydrogen Peroxide as a pore forming agent. Specifically, after firing to 1425° the porosity of batch Composition J (without the graphite pore former and comprising hydrogen peroxide) decreased from 53% to 44% relative to Batch Composition (I). Further, the median pore size decreased only modestly from 18 um to 15 um. In still a further comparison, the batch composition comprising 10% graphite in combination with hydrogen peroxide provided a total porosity that increased drastically to over 60% with a median pore size of greater than 33 μm, which is greater than the reference composition (I) possessing 3 times the amount of graphite.

It should also be understood that while the present invention has been described in detail with respect to certain illustrative and specific aspects thereof, it should not be considered limited to such, as numerous modifications are possible without departing from the broad scope of the present invention as defined in the appended claims.

What is claimed is:

1. A method for manufacturing a porous ceramic article, comprising the steps of:
providing a plasticized ceramic precursor batch composition including:
i) ceramic forming inorganic batch components;
ii) a liquid vehicle;
iii) an organic binder system; and
iv) a pore forming agent comprising at least one peroxide containing compound;
forming an extruded green body from the plasticized ceramic precursor batch composition; and
firing the green body under conditions effective to convert the extruded green body into a ceramic article comprising a porous sintered phase composition.

2. The method of claim 1, wherein the inorganic batch components are selected to provide a sintered phase cordierite composition, as characterized on a oxide weight basis, consisting essentially of:
about 49 to about 53 percent by weight SiO₂,
about 33 to about 38 percent by weight Al₂O₃, and
about 12 to about 16 percent by weight MgO.

3. The method of claim 1, wherein the inorganic batch components are selected to provide a sintered phase mullite composition.

4. The method of claim 1, wherein the inorganic batch components are selected to provide a sintered phase aluminum titanate composition.

5. The method of claim 1, wherein the at least peroxide containing compound is hydrogen peroxide.

6. The method of claim 5, wherein the hydrogen peroxide is approximately a 10% to 50% dilute hydrogen peroxide solution.

7. The method of claim 1, wherein the at least one peroxide containing compound is present in an amount in the range of from 0.1 weight % to approximately 3 weight % relative to the total weight of the inorganic batch components.

8. The method of claim 1, wherein formed extruded green body is a formed honeycomb green body.

9. The method of claim 1, wherein the formed extruded green body is at least substantially dried at a temperature below approximately 400° C. prior to firing the green body.

10. The method of claim 9, wherein the drying step accelerates an evolution of pore forming gas from the peroxide containing compound.

11. The method of claim 1, wherein the effective firing conditions comprise firing the green body at a maximum soak temperature in range of from 1350° C. to 1450° C. and subsequently holding the maximum soak temperature for a period of time sufficient to convert the honeycomb green body into ceramic article comprising a primary sintered phase composition.

12. The method of claim 11, wherein the maximum soak temperature is in the range of from approximately 1415° C. to approximately 1435° C.

13. A plasticized ceramic precursor batch composition, comprising:
i) ceramic forming inorganic batch components;
ii) a liquid vehicle;
iii) an organic binder system; and
iv) a pore forming agent comprising at least one peroxide containing compound
wherein the plasticized ceramic precursor batch composition is capable of forming a porous ceramic article comprising a primary sintered phase composition.

14. The plasticized ceramic precursor batch composition of claim 13, wherein the inorganic batch components are selected to provide a sintered phase cordierite composition, as characterized on a oxide weight basis, consisting essentially of:
about 49 to about 53 percent by weight SiO₂,
about 33 to about 38 percent by weight Al₂O₃, and
about 12 to about 16 percent by weight MgO.

15. The plasticized ceramic precursor batch composition of claim 13, wherein the inorganic batch components are selected to provide a sintered phase mullite composition.

16. The plasticized ceramic precursor batch composition of claim 13, wherein the inorganic batch components are selected to provide a sintered phase aluminum titanate composition.

17. The plasticized ceramic precursor batch composition of claim 13, wherein the at least one peroxide containing compound is hydrogen peroxide.

18. The plasticized ceramic precursor batch composition of claim 17, wherein the hydrogen peroxide is a 10% to 50% dilute hydrogen peroxide solution.

19. The plasticized ceramic precursor batch composition of claim 13, wherein the at least one peroxide containing compound is present in an amount in the range of from 0.1 weight % to approximately 3 weight % relative to the total weight of the inorganic batch components.

20. The article produced by the method of claim 1.
